(19) United States
(12) Patent Application Publication
(10) Pub. No.: US 2018/0245785 A1
(43) Pub. Date: Aug. 30, 2018

(54) HEAT SINK AND LED LIGHT BULB HAVING HEAT SINK

(71) Applicant: ZHEJIANG SHENGHUI LIGHTING CO., LTD., Jiaxing (CN)

(72) Inventors: Lu DENG, Jiaxing (CN); Guozhong ZHANG, Jiaxing (CN)

(21) Appl. No.: 15/752,733

(22) PCT Filed: Jun. 29, 2017
(86) PCT No.: PCT/CN2017/090692

§ 371 Date: Feb. 14, 2018

(30) Foreign Application Priority Data
Jun. 30, 2016 (CN) 201610527799.9

(51) Int. Cl. F21V 29/70; F21K 9/232; F21V 23/00

(52) U.S. Cl. CPC F21V 29/70; F21Y 2115/10; F21V 23/009; F21K 9/232

(57) ABSTRACT

The present disclosure provides a heat sink and an LED light bulb having the heat sink, in which the heat sink is processed by integral bending of a metal plate to form a one-piece structure. The main parts of the heat sink are two spaced side plates and one connecting plate jointing the two side plates. The relative cost is lower than an inblock metal die-casting and the relative shaping process is simpler. Further, the heat sink, an LED light source and other components are accommodated inside a glass housing which is jointed to a base to achieve an overall configuration identical to the traditional light bulbs. Accordingly, the present disclosure makes the structural design of the LED light source more flexible, easier to achieve wide-angle emitting design.

### CROSS-REFERENCE TO RELATED APPLICATION

This application is a national phase entry under 35 U.S.C. § 371 of International Application No. PCT/CN2017/090692, filed on Jun. 29, 2017, which claims priority of Chinese Patent Application No. 201610527799.9, filed on Jun. 30, 2016, the entire contents of both of which are hereby incorporated by reference.

### FIELD OF THE DISCLOSURE

The present disclosure relates to the field of the LED illumination technologies. In particular, it relates to a heat sink and an LED light bulb having the heat sink.

### BACKGROUND

In view of the appearance, the conventional LED light bulbs usually have a look which is different from the traditional light bulbs. Most conventional LED light bulbs have a semi-sphere bulb housing, attaching to one end of a barrel-shaped heat sink. Compared to one traditional light bulb, the heat sink of the conventional LED light bulb occupies almost one-half of the volume size, leaving a smaller available space to build in other components. It thus brings limitations to structural design for the LED light source of the LED light bulb, especially causing difficulties when designing lights having wide-angle emission. Moreover, in the prior art, the heat sinks of the conventional LED light bulbs are generally formed by an inblock die-casting with a bigger volume and a higher cost. The LED filament lights may avoid some of the above-identified problems; however, the drawbacks of high cost, complicated processing, low reliability, short life-cycle and heat dissipation still exist.

### BRIEF SUMMARY OF THE DISCLOSURE

In light of the foregoing, the present disclosure is directed to solve the deficiencies in the prior art. The present disclosure provides a heat sink formed by a simple and low-cost processing. The heat sink is processed by integral bending of a metal plate to form a one-piece structure, the main parts of which are two spaced side plates. The relative cost is lower than an inblock metal die-casting and the relative shaping process is simpler. The present disclosure further provides a LED light bulb, in which the heat sink, the LED light source and other components are accommodated inside a glass housing. The glass housing is then jointed to a base to achieve an overall appearance identical to the traditional light bulbs. Accordingly, the present disclosure makes the structural design of the LED light source more flexible, easier to achieve a wide-angle emitting design. The heat generated by the LED light source is thermally conducted to the base through the heat sink, thereby solving the heat dissipation problem. Meanwhile, the overall assembly is also simpler.

One aspect of the present disclosure provides a heat sink which comprises a supporting portion having two spaced supporting plates and a connecting plate jointing the two supporting plates, and a heat-conducting portion attached to the supporting plates; wherein the heat sink is bent from an integral metal plate to form the supporting portion and the heat-conducting portion. The supporting portion provides a support to a heat generating electrical component, while the heat-conducting portion is used for heat dissipation of the heat generating electrical component.

As one aspect of the present disclosure, the heat sink further comprises at least one sustaining plate being bent from the metal plate to position between the supporting plates for an aid support to the LED light source. With this arrangement, each face of the LED light source is well-supported. In one embodiment, the sustaining plate is on a plane perpendicular to the supporting plates. For a better thermal conduction, the metal plate is made of aluminum to spread out the heat more efficiently.

Another aspect of the present disclosure provides an LED light bulb having a heat sink which comprises an LED light source used to provide a light source, having LED chips; a driver arranged in an electrical connection with the LED light source to drive and control the LED light source to emit light; a base electrically connecting the driver to an outside power source; a heat sink having a supporting portion and a heat-conducting portion, wherein the supporting portion comprises two spaced supporting plates and a connecting plate jointing the supporting plates to provide a support underneath the LED light source; the heat-conducting portion is attached to the supporting plates for heat dissipation of the LED light source; and the heat sink is bent from an integral metal plate to form the supporting portion and the heat-conducting portion; and a housing combined to the base to define an inner space to accommodate the LED light source, the heat sink and the driver to integrate as the claimed LED light bulb.

In one embodiment, the present disclosure further comprises an insulator to space the heat sink from the electrical connection for insulation, thereby avoiding short circuit. Optionally, the insulator is of a hollow-ring shape, and the heat-conducting portion has an interference fit with the insulator so that the heat-conducting portion is inserted into the insulator for the electrical insulation. For instance, the insulator comprises insertion slots and the heat-conducting portion is inserted into the insertion slots for the electrical insulation. In another instance, the insulator further comprises insertion grooves to receive and secure the driver.

In consideration of enhancing diffusion reflection, the housing of the disclosed LED light bulb is made of non-transparent glass, and in one instance, the housing and the base are glued together.

The present disclosure also provides the LED light source is of a prism configuration and at least two faces of the prism are in contact with the supporting portion of the heat sink for a support. Optionally, the prism is a rectangular prism which has a top face and four side faces, all disposed with the LED chips.

The disclosed LED light bulb further comprises a protection cover which is shelved onto the LED light source. Accordingly, the LED light source can be firmly secured onto the heat sink. In one instance, the protection cover comprises a plate of a hollow polygon shape and a plurality of stopping pillars extending from each vertex of the polygon, wherein the LED chips are arranged and exposed between two adjacent stopping pillars. And the protection cover and the supporting portion of the heat sink are hooked to combine and secure the LED light source in between.

Consistent with the disclosed LED light bulb, the driver comprises pins and the LED light source comprises a pin socket, wherein the pins are inserted into the pin socket for the electrical connection of the LED light source to the driver, thereby avoiding the soldering process.

Compared to the prior art, the present disclosure provides a heat sink formed by a simple and low-cost processing. The heat sink is processed by integral bending of a metal plate to form a one-piece structure, the main parts of which are two spaced side plates. The relative cost is lower than an inblock metal die-casting and the relative shaping process is simpler.

Further, the present disclosure provides an LED light bulb whose configuration is identical to the traditional light source. The heat sink, the LED light source and other components are accommodated inside a glass housing which is jointed to a base to achieve an overall configuration identical to the traditional light bulbs. Accordingly, the present disclosure makes the structural design of the LED light source more flexible, easier to achieve wide-angle emitting design. The heat generated by the LED light source is thermally conducted to the base through the heat sink, thereby solving the heat dissipation problem. Meanwhile, the overall assembly is also simpler. The driver is installed inside the heat sink and connects the LED light source via pins. This arrangement makes the assembly easier for the electrical connection.

### BRIEF DESCRIPTION OF THE DRAWINGS

The following drawings are merely examples for illustrative purposes according to various disclosed embodiments and are not intended to limit the scope of the present disclosure in any way.

FIG. 1 is a front view of an LED light bulb consistent with the present disclosure;

FIG. 2 is a sectional view of the LED light bulb as illustrated in FIG. 1 according to embodiments of the present disclosure;

FIG. 3 is an exploded view of one exemplary embodiment of the present inventive LED light bulb having a heat sink;

FIG. 4 shows another exploded view of the disclosed LED light bulb viewed from another side of FIG. 3;

FIG. 5 is a perspective view of the heat sink according to one exemplary embodiment of the present disclosure;

FIG. 6 illustrates a perspective view of an LED light source according to one exemplary embodiment of the present disclosure;

FIG. 7 is an exploded view of the LED light source consistent with the present disclosure; and

FIG. 8 is a perspective view showing a connection of the heat sink to an insulator according to one exemplary embodiment of the present disclosure.

### DETAILED DESCRIPTION

Detailed descriptions and technical contents according to embodiments of the present disclosure will be described with reference to the accompanying drawings shown below. In addition, the drawings are not necessarily prepared in an actual proportion. It is apparent that the proportions of the drawings are not intended to limit the scope of the present disclosure as claimed.

The present disclosure provides a heat sink. The heat sink may also be referred as a heat dissipator. The heat sink may be used in electrical appliances (e.g., a light bulb) for dissipating heat generated by a heat source (e.g., LED driver). The heat sink has a compact structure and can be implemented in electrical appliances with limited space for heat dissipation.

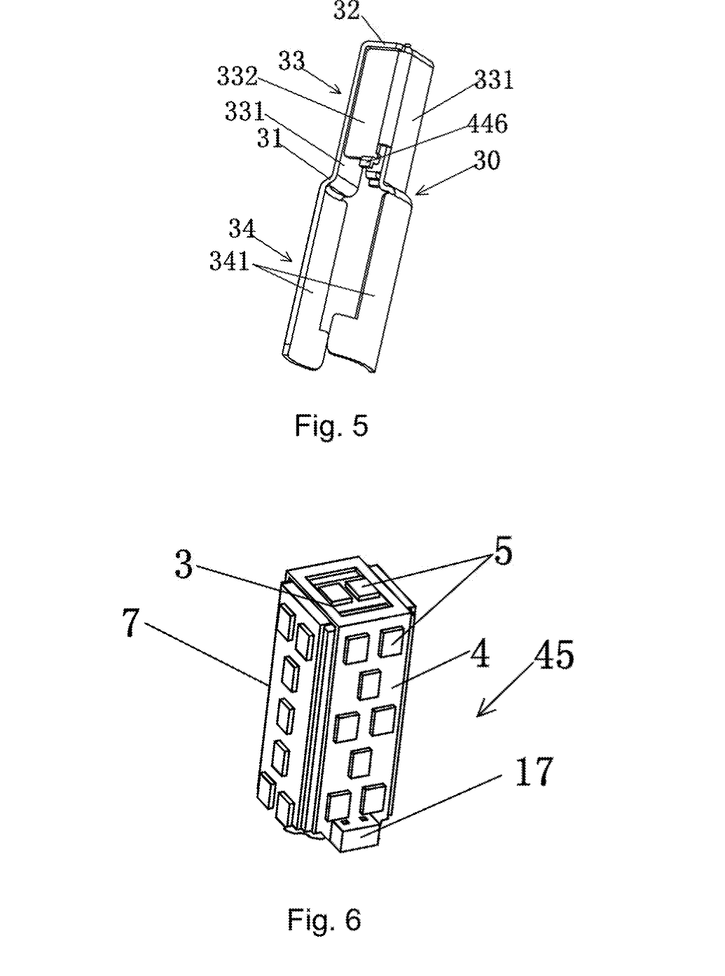

FIG. 5 illustrates a perspective view of an exemplary heat sink according to one embodiment of the present disclosure. The heat sink may have a one-piece structure formed by a bent metal plate 30. Specifically, to form the essential structure of the heat sink, a metal plate 30 is bent to define two spaced side plates 31, and a connecting plate 32. The corresponding ends of the two spaced side plates 31 are connected by the connecting plate 32. The bent metal plate 30 may generally have a U shape. In other words, the two spaced side plates 31 may be located at opposite sides of a center axis of the heat sink. The material of the metal plate 30 may be aluminum for desired heat dissipation.

The heat sink as integrally formed may include a supporting portion 33, a heat-conducting portion 34 and the connecting plate 32. The supporting portion 33 is disposed underneath a heat generating electrical component (e.g., an LED light source) to support the electrical component. The supporting portion 33 includes two spaced supporting plates 331 which are connected by the connecting plate 32. The heat-conducting portion 34 includes two spaced heat-conducting plates 341. Further, the supporting plate 331 and the corresponding heat-conducting plate 341 are combined to define the side plate 31 at each side. In other words, each side plate 31 may include one supporting plate 331 and one heat-conducting plate 341 that are integrally connected.

In one instance, at each side, the supporting plate 331 and the heat-conducting plate 341 may be laid on an identical plane, while, in another instance, the supporting plate 331 and the heat-conducting plate 341 may be configured to have a step difference (e.g., connected by a turning piece) but remain parallel as illustrated in FIG. 5. In one embodiment, the supporting portion 33 may further include at least one sustaining plate 332 disposed at a location in between the supporting plates 331 for an aid support to the heat generating electrical component (e.g., the LED light source). In shaping process, the sustaining plate 332 can be attached to the connecting plate 32 at one end and bent to the position between the two supporting plates 331 so that the sustaining plate 332 is on a plane perpendicular to the plane of the supporting plates 331. Alternatively, the sustaining plate 332 can be attached to the supporting plate 331 at one end and bent to a desired position between the two supporting plates 331.

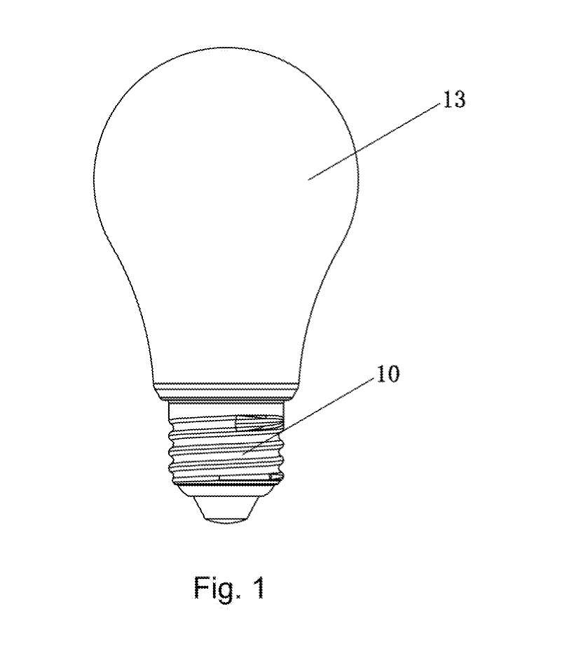

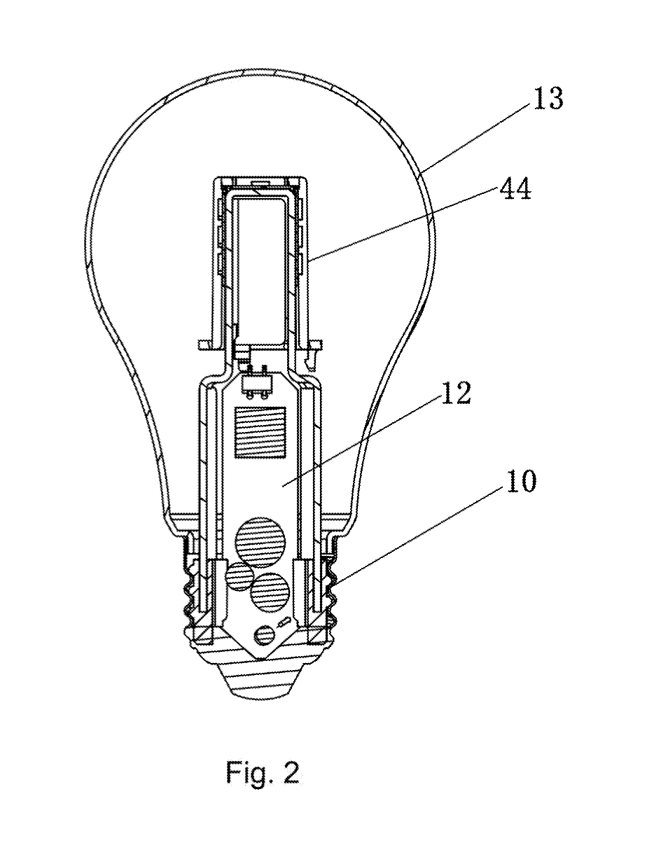

As illustrated in FIGS. 1 to 4, the present disclosure further provides a Light Emitting Diode (LED) light bulb (or an LED lighting device) having a heat sink. An exemplary LED light bulb may include: an LED light source 45, a driver 12, a housing 13, a base 10 and a heat sink 41. The LED light source 45 is applied to emit light and provide general lighting to an indoor/outdoor space, while the driver 12 is electrically connected to the LED light source 45 and is configured to drive and control the LED light source 45 to emit light when being turned on. The base 10 is attached to the driver 12 to connect the driver 12 to an external power source (not shown herein). The heat sink 41 may be the heat sink illustrated in FIG. 5, and may be implemented to dissipate the heat generated by LED light source 45. In assembly, the housing 13 is fastened to the base 10 to form an inner space to accommodate the LED light source 45, the driver 12 and the heat sink 41 inside the housing 13. In one instance, the housing 13 and the base 10 are fastened by glue. The housing 13 is adapted to perform diffusion reflection to the light emitted by the LED light source 45. The housing 13 may be non-transparent and made of glass.

In some embodiments, the disclosed LED light bulb may further include an insulator 21 to space the heat sink 41 from the driver 12 and the LED light source 45 for electrical insulation. The insulator 21 is made of a thermal conducting plastic material. The insulator 21 is of a hollow-ring shape to receive and install the driver 12 inside, and the insulator 21 is disposed in a way so that the heat sink 41 is spaced from the driver 12 for the electrical insulation. In one instance, the heat-conducting portion 34 as inserted into the insulator 21 has an interference fit with the insulator 21 to space from the driver 12. More specifically, as illustrated in FIG. 5, the insulator 21 includes insertion slots 42 compatible with the heat-conducting portion 34. Accordingly, the heat-connecting plates 341 of the heat sink 41 can be inserted into the corresponding insertion slots 42 for the electrical insulation. In assembly, the insulator 21 may have external threads and can be joined/connected to the base 10 by threads.

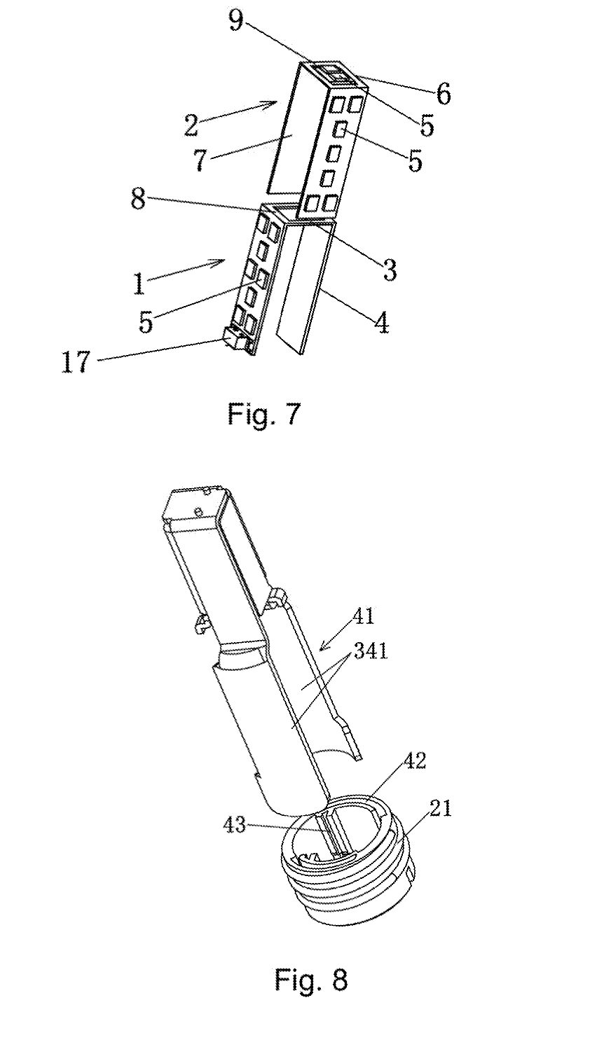

Regarding to the LED light source 45, in reference to FIGS. 6 and 7, the LED light source 45 may include one or more LED chips 5 to emit light. The LED light source 45 sits onto the heat sink 41 when the LED light source 45 is assembled to the heat sink 41. In one embodiment, the LED light source 45 as a whole has a prism shape or a cuboid shape. Accordingly, the LED light source 45 has at least two inner faces in contact with the supporting portion 33 of the heat sink 41. For example, the supporting portion 33 is inserted into the LED light source 45 in assembly. The LED light source 45 may have a rectangular prism shape and the LED chips 5 can be arranged on one top face and one or more of the four side faces connecting the top face as illustrated in FIG. 6.

More specifically, in reference to FIGS. 6 and 7, the LED light source 45 may include a first LED strip 1 and a second LED strip 2, each holding one or more LED chips 5 for illumination. The LED strip 1 and the LED strip 2 may be stacked at illustrated or other proper angle/position to expose all LED chips 5. The first LED strip 1 includes a first middle portion 3, first wings 4 and a first flexible circuit board 8, while the second LED strip 2 includes a second middle portion 6, second wings 7 and a second flexible circuit board 9. The flexible circuit boards 8, 9 are adapted to host and provide control to the LED chips 5. The middle portions 3, 6 are electrically connected, for example by spot welding. The LED chips 5 are disposed on the wings 4, 7 respectively. The first wings 4 are positioned symmetrically at the two sides of the first middle portion 3, while the second wings 7 are positioned symmetrically at the two sides of the second middle portion 6. In one instance, the wings 4 may be perpendicular to the first middle portion 3, and accordingly, the wing 4 are parallelly positioned to each other. The wings 7 may be perpendicular to the second middle portion 6. Further, the first LED strip 1 and the second LED strip 2 are cross-stacked and contact each other at the middle portions 3, 6. When being stacked at the middle portions 3, 6, the uncovered middle portion (either on top or at bottom) is provided with the LED chips 5 for more illumination In one example, the middle portion at bottom may host LED chip 5, and the middle portion on top may have a through-hole. Accordingly, when the two LED strips are stacked, the LED chip 5 on the middle portion at bottom may protrude over the through-hole of the middle portion on top, thereby being exposed. In another example, the middle portion on top may host LED chip 5, and when the two LED strips are stacked, the LED chip 5 is naturally exposed. In this arrangement, the assembly is convenient and illumination for a great range of angles can be achieved.

The middle portions 3, 6 can have a rectangular shape, and the wings 4, 7 can also have a rectangular shape. The LED chips 5 are provided on the flexible circuit boards 8, 9 and disposed onto the wings 4, 7 and/or the middle portions 3, 6. In one example, the wings are formed by bending at the two sides of middle portion and connected to the middle portion. In another instance, the middle portion and the corresponding wings are separated with a space and connected by the corresponding flexible circuit board. In other words, the wings may not directly contact a corresponding middle portion but can maintain a desired positional relationship (e.g., perpendicular) with the middle portion by using the flexible circuit board as a connection piece. The flexible circuit can not only achieve the goal of an electrically connection but also flexibly be bent to perform a mechanical connection to integrate the middle portions and the corresponding wings.

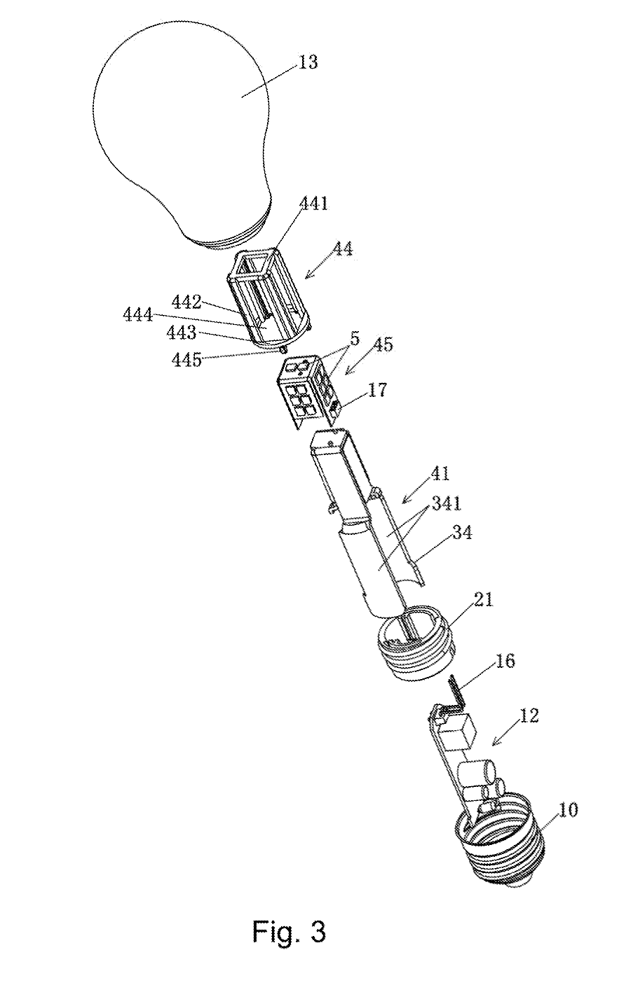

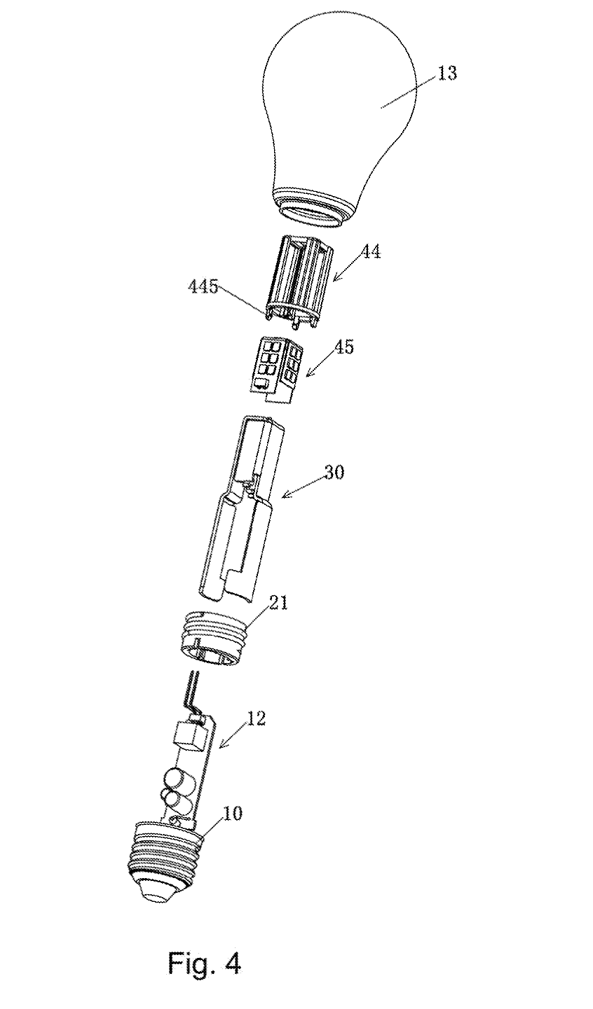

Now turning to FIGS. 3 and 4, in combination, the LED light source 45 is shelved onto the supporting portion 33 of the heat sink 41. For example, after assembly, the wings 4 and 7 may contact the supporting plates 331 and the sustaining plates 332 respectively. The present disclosure further provides a protection cover 44 covered onto the LED light source 45. The protection cover 44 includes a plate 441 of a hollow polygon shape, a plurality of stopping pillars 442 extending from each vertex of the polygon, a constraint portion 443 connecting the stopping pillars 442 at the other side, and a plurality of hooks 445 hooked to the heat sink 41 to secure the LED light source 45 between the protection cover 44 and the heat sink 41. A plurality of receiving spaces 444 are defined between two adjacent stopping pillars 442 to bring the light of the LED light source 45 out. The sustaining plate 332 of the heat sink 41 is comprised of a plurality of hangers 446 (e.g., other hooks compatible with hooks 445) at one end. When the protection cover 44 is shelved onto the LED light source 45 in combination, the hooks 445 of the protection cover 44 are hooked to the hangers 446 of the heat sink 41 to secure and constraint the LED light source 45 in between. As such, the protection cover can secure and fasten the LED light source 45 With the design of the protection cover 44 consistent with the disclosed embodiment, it solves the conventional problem in which the LED light source is glued to a supporting portion.

The insulator 21 includes insertion grooves 43 on the inner wall thereof to receive and install the driver 12. The driver 12 is a driver circuit board to electrically connect to the LED light source 45 to provide the appropriate power source and control to the LED light bulb of the present disclosure. In one instance, the driver 12 includes pins 16 to plug into a pin socket 17 of the LED light source 45 for the electrical connection.

In some embodiments, the LED light source 45 may include more than two LED strips. For example, the LED light source 45 may include three LED strips. Each LED strip includes two wings to hold the LED chips, and a middle portion similar to middle portions 3 or 6. The middle portions of the LED strips may be electrically connected. The middle portions of the LED strips may be fixed on the supporting portion 33 or the top face of the supporting portion 33. The supporting portion 33 may be a hexagonal shape, which provides supporting surfaces for the six wings of the three LED strips. In another example, the LED light source 45 may include four LED strips. Each LED strip includes two wings to hold the LED chips, and a middle portion similar to middle portions 3 or 6. The middle portions of the LED strips may be electrically connected. The middle portions of the LED strips may be fixed on the supporting portion 33 or the top face of the supporting portion 33. The supporting portion 33 may be an octagonal shape, which provides supporting surfaces for the eight wings of the three LED strips.

In some embodiments, the LED light source 50 may include straight LED wings/strips, curved wings/strips, or jagged wings/strips. In some embodiments, the supporting portion 33 may be of a cylinder or a cone shape. The LED wings 4 and 7 may be curvy strips and may be supported by the supporting portion 30.

While the present disclosure has been particularly described in terms of the preferred forms and examples, it is to be understood that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A heat sink, comprising:
a supporting portion, having two spaced supporting plates and a connecting plate jointing the supporting plates to provide a support for a heat generating electrical component; and
a heat-conducting portion attached to the supporting plates for heat dissipation of the heat generating electrical component; wherein the heat sink is bent from an integral metal plate to form the supporting portion and the heat-conducting portion.

2. The heat sink according to claim 1, wherein the supporting portion further comprises at least one sustaining plate being bent from the metal plate to position between the supporting plates.

3. The heat sink according to claim 2, wherein the sustaining plate is on a plane perpendicular to the supporting plates.

4. The heat sink according to claim 1, wherein the metal plate is made of an aluminum material.

5. An LED light bulb having a heat sink, comprising:
an LED light source used to provide a light source, having LED chips;
a driver arranged in an electrical connection with the LED light source to drive and control the LED light source to emit light;
a base electrically connecting the driver to an outside power source;
a heat sink having a supporting portion and a heat-conducting portion, wherein the supporting portion comprises two spaced supporting plates and a connecting plate jointing the supporting plates to provide a support underneath the LED light source; the heat-conducting portion is attached to the supporting plates for heat dissipation of the LED light source; and the heat sink is bent from an integral metal plate to form the supporting portion and the heat-conducting portion; and
a housing combined to the base to define an inner space to accommodate the LED light source, the heat sink and the driver to integrate as the claimed LED light bulb.

6. The LED light bulb according to claim 5, further comprising an insulator to space the heat sink from the electrical connection for insulation.

7. The LED light bulb according to claim 6, wherein the insulator is of a hollow-ring configuration, and the heat-conducting portion has an interference fit with the insulator so that the heat-conducting portion is inserted into the insulator to space from the electrical connection.

8. The LED light bulb according to claim 7, wherein the insulator comprises insertion slots and the heat-conducting portion is inserted into the insertion slots for the electrical insulation.

9. The LED light bulb according to claim 6, wherein the insulator further comprises insertion grooves to receive the driver.

10. The LED light bulb according to claim 5, wherein the supporting portion further comprises at least one sustaining plate being bent from the metal plate to position between the supporting plates for an aid support to the LED light source.

11. The LED light bulb according to claim 10, wherein the sustaining plate is on a plane perpendicular to the supporting plates.

12. The LED light bulb according to claim 5, wherein the metal plate is made of an aluminum material.

13. The LED light bulb according to claim 5, wherein the housing is made of non-transparent glass.

14. The LED light bulb according to claim 5, wherein the housing and the base are joined by glue.

15. The LED light bulb according to claim 5, wherein the LED light source is of a prism configuration and at least two faces of the prism are in contact with the supporting portion for a support.

16. The LED light bulb according to claim 15, wherein the prism is a rectangular prism having a top face and four side faces disposed with the LED chips.

17. The LED light bulb according to claim 5, further comprising a protection cover which is shelved onto the LED light source to secure the LED light source between the protection cover and the heat sink.

18. The LED light bulb according to claim 17, wherein the protection cover comprises a plate of a hollow polygon configuration and a plurality of stopping pillars extending from each vertex of the polygon, wherein the LED chips are arranged and exposed between two adjacent stopping pillars.

19. The LED light bulb according to claim 17, wherein the protection cover and the supporting portion of the heat sink are hooked to combine so as to secure the LED light source in between.

20. The LED light bulb according to claim 5, wherein the driver comprises pins and the LED light source comprises a pin socket, wherein the pins are inserted into the pin socket for the electrical connection of the LED light source to the driver.
